(19) United States
(12) Patent Application Publication
(10) Pub. No.: US 2017/0229715 A1
(43) Pub. Date: Aug. 10, 2017

(54) Method of Fabricating Bipolar Pate of Flow Cell

(71) Applicant: Institute of Nuclear Energy Research, Atomic Energy Council, Executive Yuan, R.O.C., Taoyuan City (TW)

(72) Inventors: Yi-Sin Chou, New Taipei City (TW); Yong-Song Chen, Chiayi County (TW); Chih-Hsun Chang, New Taipei City (TW); Hwa-Jou Wei, Taoyuan City (TW)

(21) Appl. No.: 15/015,203

(22) Filed: Feb. 4, 2016

(51) Int. Cl. H01M 8/0258; B29C 45/16; H01M 8/0213; H01M 8/18; H01M 8/20

(52) U.S. Cl. CPC H01M 8/0258; H01M 8/188; H01M 8/20; H01M 8/0213; B29C 45/1671; B29K 2707/04

(57) ABSTRACT

A method is provided to make a bipolar plate of a flow cell. The two insulating frames traditionally cladding the graphite plate is changed. Through injection-molding, an acid-resisting insulating material is molded on the graphite plate to form an integrated bipolar plate. Composite channels are designed around the graphite plate. Thus, the binding force between the acid-resisting insulating material and the graphite plate is increased and the risk of electrolyte leakage is reduced. In order to reduce shunt currents, branch channels are also made in the frame through injection-molding. By using the bipolar plate thus made accordingly, not only the possibility of electrolyte leakage but also the number of components and the time for processing assembly can be significantly reduced. The cost of processing and assembly is effectively decreased. Accordingly, the present invention simplifies the structure of bipolar plate with cost reduced.

### TECHNICAL FIELD OF THE INVENTION

The present invention relates to a bipolar plate; more particularly, relates to an all-vanadium redox battery having an integrated bipolar plate formed with an acid-resistant insulating material injection-molded around a graphite plate.

### DESCRIPTION OF THE RELATED ART

All-vanadium redox battery uses different valence states of vanadium ions in electrolytes for storing or releasing energy through a redox reaction. The electrodes themselves do not participate in the reaction; and, the positive and negative electrolytes are separated and stored in external reservoirs, where the battery has a low self-discharging rate and a long life for cycling. Its characteristic is that the level of battery power and that of energy storage can be designed separately.

The structural design of the battery has to consider distribution of the electrolytes in reaction area while reducing shunt currents. The all-vanadium battery can comprise a plurality of unit cells connected in series. Because the electrolytes are conductive, a current (i.e. shunt current) may be formed by the electrolytes connecting any two cells owing to potential difference. This current does not supply required external load and so is a friction. Most of the way for reducing this current is by increasing the length of the flowing channels from the main channel to the reaction area for increasing resistance of the electrolytes contained in between. These flowing channels are designed on an external frame made of an insulating material; and, consequently, the whole structure of the vanadium battery becomes complex.

The traditional structure of the all-vanadium battery is shown in FIG. 6. Therein, the bipolar plate 3 is made by clamping a graphite plate 32 with two insulating frames 31, where the function of the graphite plate 32 is to separate the positive and negative electrolytes as well as conducting electrons with branch channels 311 located on the insulating frames 31. On assembling, each layer of contact surfaces needs to be set with an airtight gasket 33 for preventing electrolyte leakage. However, required components for this kind of battery structure are many and time consumes for assembling, which results in cost increased.

Hence, the prior art does not fulfill all users' requests on actual use.

### SUMMARY OF THE INVENTION

The main purpose of the present invention is to fabricate an integrated bipolar plate formed with an acid-resistant insulating material injection-molded around a graphite plate.

Another purpose of the present invention is to obtain composite grooves on a frame around the graphite plate and simultaneously obtain branch channels through injection-molding on the frame for reducing shunt currents.

Another purpose of the present invention is to increase a binding force between the acid-resistant insulating material and the graphite plate and reduce risk of electrolyte leakage for significantly reducing number of elements and time for assembling, where costs of processing and assembly are thus effectively reduced.

To achieve the above purposes, the present invention is a method of fabricating a bipolar plate of a flow cell, comprising steps of: (a) providing a conductive graphite plate, where the graphite plate has an upper surface and a lower surface and a plurality of first leak-proof grooves are formed at periphery on each of the upper surface and the lower surface; (b) providing an injection-molding jig to be positioned at inner edge of the graphite plate to hold the graphite plate; (c) using the injection-molding jig to mold a frame around the graphite plate through injection molding with an acid-resistant insulating material and forming a plurality of branch channels on the frame for obtaining an integrated bipolar plate; and (d) obtaining a plurality of cover plates covering over the branch channels on the frame and obtaining a second leak-proof groove on a contact surface between each of the cover plates and the frame. Accordingly, a novel method of fabricating a bipolar plate of a flow cell is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the explosive view showing the preferred embodiment according to the present invention;

FIG. 2 is the structural view showing the graphite plate;

FIG. 3 is the structural view showing the integrated bipolar plate;

FIG. 4 is the structural view showing the cover plates;

FIG. 5 is the cross-sectional view showing the injection-molding jig at line A-A in FIG. 3; and

FIG. 6 is the explosive view of the prior art.

### DESCRIPTION OF THE PREFERRED EMBODIMENT

The following description of the preferred embodiment is provided to understand the features and the structures of the present invention.

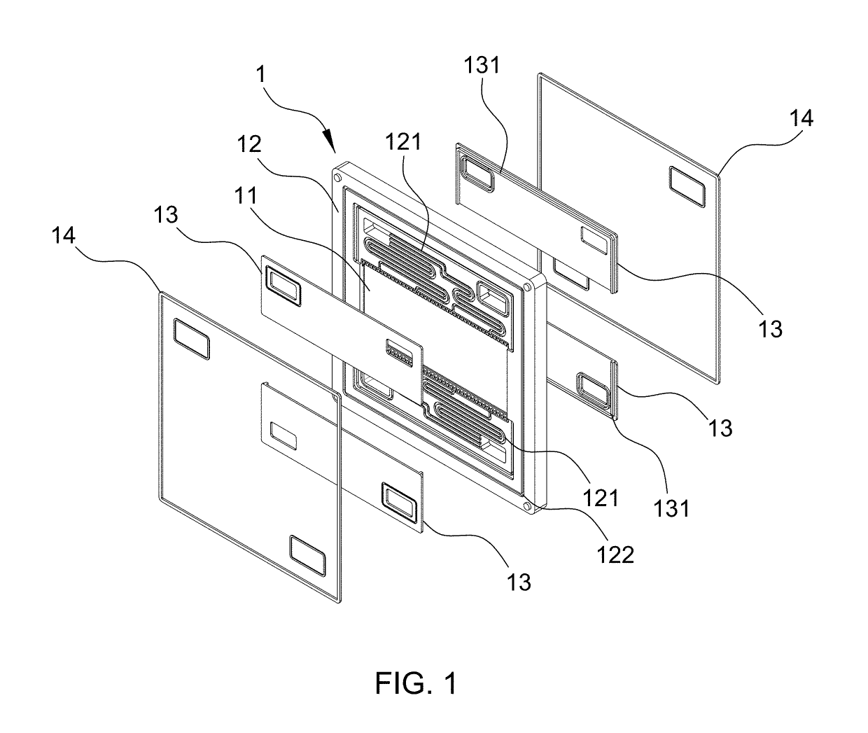

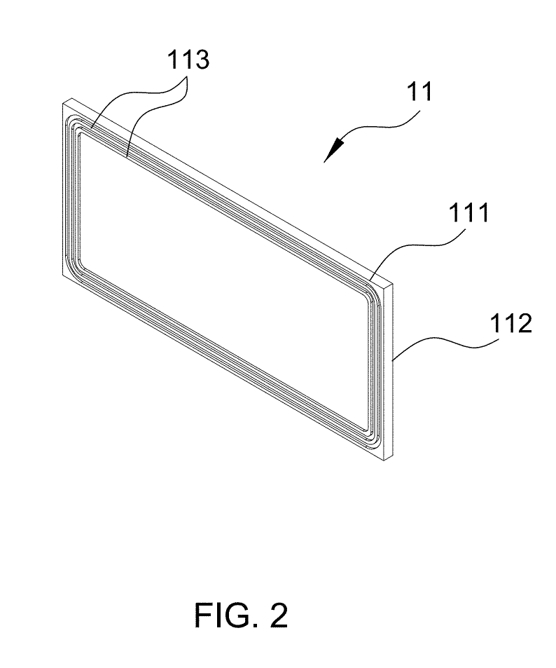

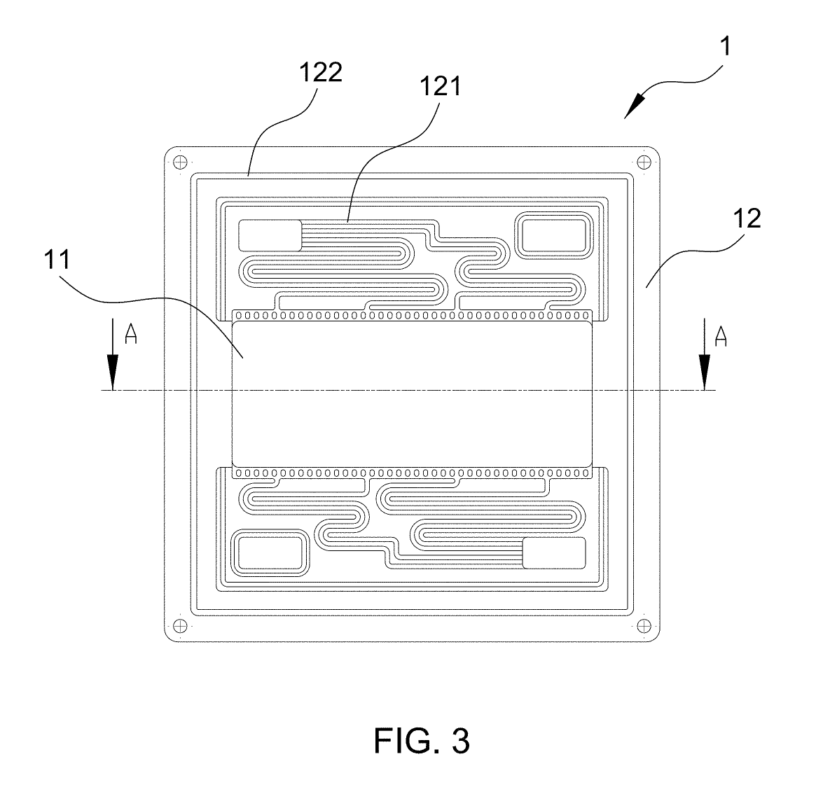

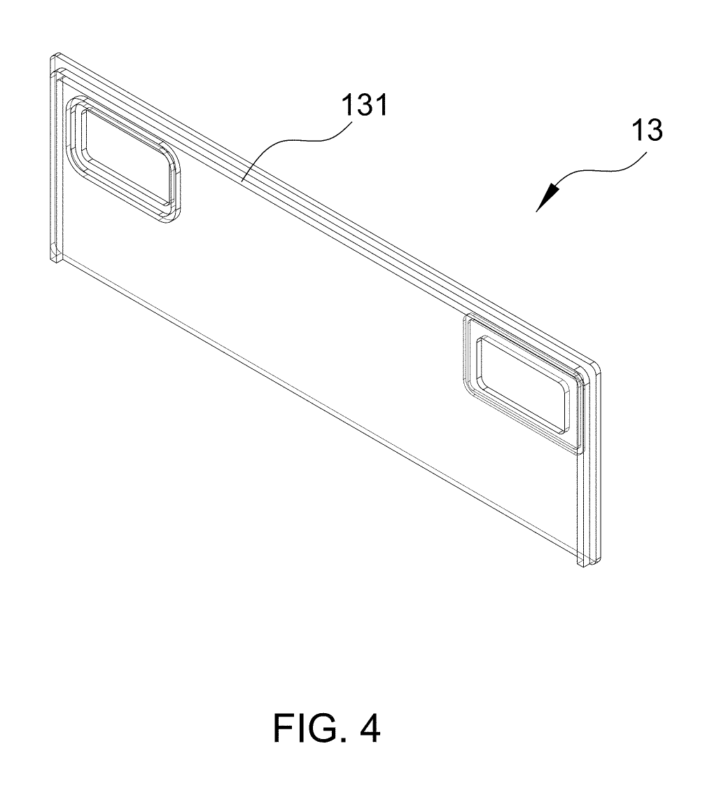

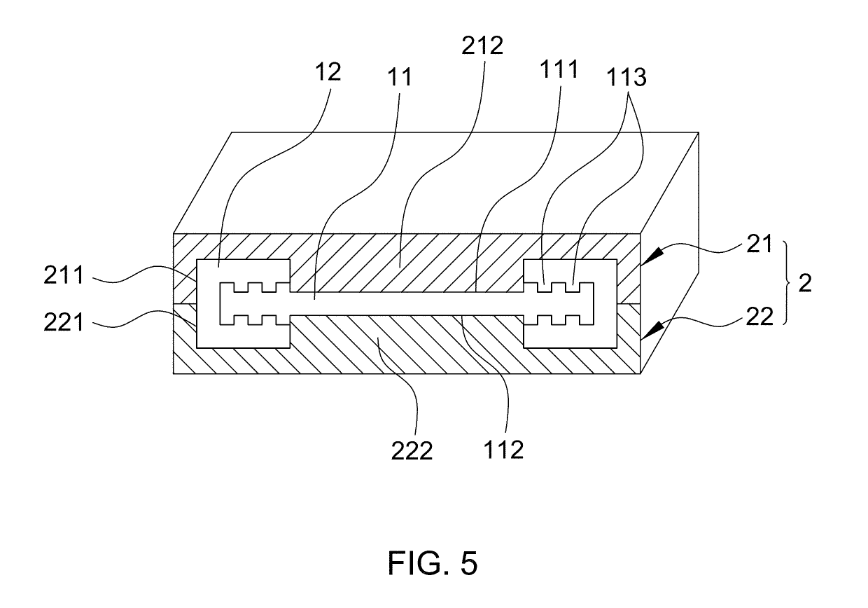

Please refer to FIG. 1˜FIG. 5, which are an explosive view showing a preferred embodiment according to the present invention; structural views showing a graphite plate, an integrated bipolar plate and cover plates; and a cross-sectional view showing the integrated bipolar plate at line A-A in FIG. 3. As shown in the figures, the present invention is a method of fabricating a bipolar plate of a flow cell, comprising the following steps:
(a) A conductive graphite plate 11 is provided. In FIG. 2 and FIG. 5, the conductive graphite plate 11 has an upper surface 111 and a lower surface 112; and, a plurality of first leak-proof grooves are formed at periphery on a surface of each of the upper surface 111 and the lower surface 112.
(b) An injection-molding jig 2 is provided to be positioned at inner edge of the graphite plate 11 for holding the graphite plate 11.
(c) The injection-molding jig 2 is used to mold a frame 12 around the graphite plate 11 through injection molding with an acid-resistant insulating material like epoxy resin, polyimide or acrylic. Meanwhile, a plurality of branch channels 121 are simultaneously molded on the frame 12 through the injection molding to form an integrated bipolar plate 1, as shown in FIG. 3. Therein, at outer part of periphery of the frame 12, a sealing groove 122 is further provided to embed a gasket 14 into the sealing groove 122 of the integrated bipolar plate 1 for forming a sealed structure.
(d) A plurality of cover plates 13 are covered over the branch channels 121 on the frame 12. A second leak-proof groove 131 is formed on a contact surface between each cover plate 13 and the frame 12. As shown in FIG. 4, the second leak-proof groove 131 is formed into an ‘n’-like shape at periphery of an inner surface of each cover plate 13.

Thus, a novel method of fabricating a bipolar plate of a flow cell is obtained.

In FIG. 5 (the cross-sectional view at line A-A of FIG. 3), the injection-molding jig 2 comprises an upper mold 21; and a lower mold 22 corresponding to the upper mold 21. A cavity of the upper mold 21 and a cavity of the lower mold 22 are coordinated to form half of a shape of the integrated bipolar plate 1 with a symmetrical structure. Therein, on corresponding surfaces of the upper mold 21 and the lower mold 22, an upper cavity 211 and an upper positioning block 221 together with a lower cavity 212 and a lower positioning block 222 are respectively set as corresponding to a shape of the integrated bipolar plate 1.

As shown in FIG. 2, the present invention designs two of the first leak-proof grooves 113 outside of a reaction area of the frame 12 and the graphite plate 11 to increase engagement between the graphite plate 11 and the acid-resistant insulating material for preventing electrolyte circulation on both sides of the integrated bipolar plate 1. On using the present invention, the two first leak-proof grooves 113 around the graphite plates 11 help the injection-molding jig 2 clamping. The upper positioning block 212 is positioned to adhere to the first leak-proof groove 113 surrounded at inner part of periphery of the upper surface 111 of the graphite plate and is clamped by the lower mold 22. The lower positioning block 222 is positioned to adhere to the first leak-proof groove 113 surrounded at inner part of periphery of the lower surface 112 of the graphite plate 11 and is clamped by the upper mold 21. Thus, the upper and the lower molds 21,22 clad the graphite plate 11 and are fixed to positions, as shown in FIG. 5. Furthermore, as shown in FIG. 4, the present invention uses the cover plates 13 covering over the branch channels 121 to avoid electrolytes existed in the branch channels 121 from directly contacting a proton exchange membrane, where a use-life of the proton exchange membrane is not decreased and the proton exchange membrane is prevented from being dropped into the branch channels 121 to make the electrolytes blocked. On the contact surface between the cover plate 13 and the frame 12, the second leak-proof groove 131 is also set to prevent the electrolytes from leaking from the cover plate 13.

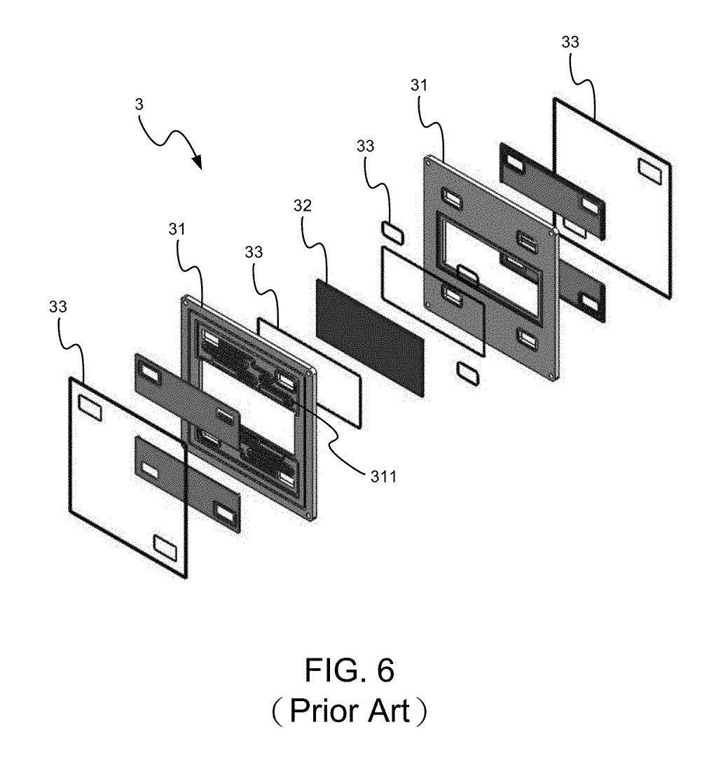

Hence, the present invention fabricates an integrated bipolar plate formed with an acid-resistant insulating material injection-molded around a graphite plate, instead of cladding the graphite plate by being clamped with two insulating frame. Composite grooves are set on a frame around the graphite plate to increase a binding force between the acid-resistant insulating material and the graphite plate and reduce risk of electrolyte leakage. Branch channels are simultaneously made on the frame for reducing shunt currents. By applying the integrated bipolar plate in a cell stack, not only possibility of electrolyte leakage is effectively decreased; but also number of elements and time for assembling are significantly reduced, where costs of processing and assembly are thus effectively reduced. By comparing FIG. 1 and FIG. 6, it is found that the integrated bipolar plate is simplified with much fewer elements than a conventional bipolar plate. Accordingly, the present invention simplifies structure to reduce cost for obtaining advantage over all-vanadium redox flow batteries used in energy storage systems.

To sum up, the present invention is a method of fabricating a bipolar plate of a flow cell, where an integrated bipolar plate is formed with an acid-resistant insulating material injection-molded around a graphite plate; composite grooves are set on a frame around the graphite plate for increasing a binding force between the acid-resistant insulating material and the graphite plate and reducing risk of electrolyte leakage; branch channels are simultaneously made on the frame for reducing shunt currents; number of elements and time for assembling are significantly decreased; and costs of processing and assembly are effectively reduced.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of fabricating a bipolar plate of a flow cell, comprising steps of:
(a) providing a conductive graphite plate,
wherein said graphite plate has an upper surface and a lower surface and a plurality of first leak-proof grooves are obtained at periphery on each of said upper surface and said lower surface;
(b) providing an injection-molding jig to be positioned at inner edge of said graphite plate to hold said graphite plate;
(c) using said injection-molding jig to mold a frame around said graphite plate through injection molding with an acid-resistant insulating material and obtaining a plurality of branch channels on said frame to obtain an integrated bipolar plate; and
(d) obtaining a plurality of cover plates covering over said branch channels on said frame and obtaining a second leak-proof groove on a contact surface between each of said cover plates and said frame.

2. The method according to claim 1,
wherein said branch channels are molded on said frame through said injection molding.

3. The method according to claim 1,
wherein, at outer part of periphery of said frame, a sealing groove is further obtained to embed a gasket into said sealing groove of said integrated bipolar plate.

4. The method according to claim 1,
wherein said injection-molding jig comprises an upper mold and a lower mold; said lower mold is corresponding to said upper mold; and a cavity of said upper mold and a cavity of said lower mold are coordinated to obtain half of a shape of said integrated bipolar plate with a symmetrical structure.

5. The method according to claim 4,
wherein, on corresponding surfaces of said upper mold and said lower mold, an upper cavity and an upper positioning block together with a lower cavity and a lower positioning block are respectively obtained as corresponding to said shape of said integrated bipolar plate;
wherein said upper mold and said lower mold correspondingly clamp a graphite plate in said integrated bipolar plate;
wherein said upper positioning block is positioned to adhere to a first leak-proof groove surrounded at inner part of periphery of an upper surface of said graphite plate and is clamped by said lower mold;
wherein said lower positioning block is positioned to adhere to said first leak-proof groove surrounded inner part of periphery of a lower surface of said graphite plate and is clamped by said upper mold; and
wherein said upper and lower molds thus clad said graphite plate and are fixed to positions.

6. The method according to claim 1,
wherein said insulating material is selected from a group consist of epoxy resin, polyimide and acrylic.

7. The method according to claim 1,
wherein said second leak-proof groove is obtained at periphery of an inner surface of each of said cover plates to form an ‘n’-like shape.
